(19) United States
(12) Patent Application Publication
(10) Pub. No.: US 2006/0255770 A1
(43) Pub. Date: Nov. 16, 2006

(54) Method for controlling the life of a battery and corresponding device

(76) Inventors: Jacques Rocher, Saint-Orens (FR); Frederic Stuyk, Toulouse (FR)

Correspondence Address: YOUNG & THOMPSON, 745 SOUTH 23RD STREET, 2ND FLOOR, ARLINGTON, VA, 22202, US

(21) Appl. No.: 11/398,540

(22) Filed: Apr. 6, 2006

(30) Foreign Application Priority Data
Apr. 6, 2005 (FR) 0503385

(51) Int. Cl. H02J 7/04

(52) U.S. Cl. 320/144

(57) ABSTRACT

The invention relates to a method and a device for controlling the life of a battery (5) such as a cell, particularly a lithium/manganese cell. According to the method of the invention, a voltage raiser electrically supplied by the battery and adapted to make up for any deficiencies of the latter is used, an indicator parameter of the operation of the battery is selected, and a threshold value of said indicator parameter, below which said battery is considered to be incapable of having a satisfactory performance, is fixed and stored, the indicator parameter is then measured periodically, and the supply to the voltage raiser is triggered if, and only if, the measured value of said indicator parameter becomes lower than the stored threshold value.

The invention relates to a method and a device for controlling the life of a battery such as a cell, particularly a lithium/manganese cell, having specific operating characteristics, in the context of a given application in which said battery is used.

This invention is applicable particularly, but not exclusively, to the automobile field, for controlling the life of cells, particularly lithium/manganese cells, incorporated into electronic modules such as electronic modules adapted to be mounted on the wheels of a vehicle in order to measure the operating parameters of said wheels and transmit these parameters towards a central unit mounted on said vehicle.

The operating characteristics which batteries such as cells must possess include, in particular, a guaranteed minimum life of said batteries in predetermined normal operating conditions, including the supply, throughout this life, of a voltage above a predetermined threshold at the terminals of these batteries.

Thus, in particular, in the automobile field, the cells incorporated into electronic modules must have a capacity and operating characteristics such as to provide an adequate supply of electricity to the various components of these electronic modules throughout the lives of these modules specified by the automobile manufacturer.

In practice, however, the maximum voltage which can be supplied at the terminals of the batteries is, in particular, a function of the ambient temperature of the environment in which these batteries are located, and, for any one ambient temperature, this voltage decreases in line with the ageing of said batteries.

Consequently, in the context of a specific application, the “guaranteed” life of a battery, that is to say the period for which this battery is guaranteed to supply a given minimum voltage, is strongly influenced by the temperature conditions in which said battery is to operate, and these temperature conditions most commonly cause a considerable decrease in this “guaranteed” life.

The invention proposes to overcome this drawback and its essential object is to provide a method for controlling the life of a battery which results, in equivalent temperature conditions, in a significant increase in the “guaranteed” life of said battery.

To achieve this object, the invention proposes a method for controlling the life of a battery consisting of the following steps, in the context of a given application in which said battery is used,

incorporating into the application a voltage raiser electrically supplied by the battery and adapted to make up for any deficiencies in the latter,

selecting a parameter indicating the operation of the battery, and fixing and storing a threshold value of said indicator parameter below which said battery is considered to be incapable of providing an adequate supply to the application,

periodically measuring the indicator parameter and triggering the supply to the voltage raiser if, and only if, the measured value of said indicator parameter becomes lower than the stored threshold value.

(According to the invention, the term “voltage raiser” denotes an electronic function consisting in the charging of a capacitor whose energy is intended to be consumed to make up for a temporary decrease in voltage at the terminals of the battery.)

Therefore the control method according to the invention consists, in the first place, of using a voltage raiser to compensate for any deficiencies of a battery, due essentially to operation in low temperature conditions, and thus to ensure that a voltage above a predetermined threshold is obtained at the terminals of this battery.

However, since the operation of the voltage raiser causes a consumption of energy, the method also consists in the control of this operation, and in the triggering of the supply to this voltage raiser only when the battery is found to be incapable of providing an adequate power supply to the application.

Thus the method according to the invention makes it possible to guarantee that a given minimum voltage will be obtained at the terminals of a battery throughout the life of this battery, by using a voltage raiser controlled in such a way that its operation has a minimal effect on the discharge of said battery.

In addition, as mentioned above, a step preliminary to the control method according to the invention consists in selecting a parameter which indicates the operation of the battery, and which can be used to determine whether or not the battery is capable of providing an adequate power supply to the application.

According to the invention, the indicator parameter selected can consist of a parameter representing the operation of the battery. In an advantageous embodiment, it is thus possible to select the voltage at the terminals of the battery as the indicator parameter, and to fix and store as the threshold value of said voltage a theoretical value of the minimum voltage at the terminals of said battery, called the minimum operating voltage, which ensures the operation of the application.

According to the invention, the indicator parameter selected can also consist of a parameter representing an influence on the operation of the battery. In an advantageous embodiment, it is thus possible to select the ambient temperature of the environment in which the battery is located as the indicator parameter, and to fix and store as the threshold value of said temperature a predetermined value of ambient temperature below which the battery is incapable of ensuring, throughout its life, that the minimum operating voltage of the application will be obtained.

The invention can also consist in the combination of two indicator parameters, and thus, advantageously:

in selecting a first indicator parameter consisting of the ambient temperature of the environment in which the battery is located, and a second indicator parameter consisting of the voltage at the terminals of said battery,

and, if a temperature below the corresponding threshold value is measured, in measuring the value of the second indicator parameter and triggering the supply to the voltage raiser if, and only if, the measured value of said second indicator parameter becomes lower than the corresponding stored threshold value.

As mentioned above, the invention is applicable in particular to the control of the life of a cell, particularly a lithium/manganese cell, incorporated in an electronic module adapted to be mounted on a wheel of a vehicle in order to measure operating parameters of said wheel and transmit them towards a central unit mounted on said vehicle.

In the context of this application, and advantageously, according to the invention, a parameter measured by the electronic module in the context of its monitoring application is selected as the indicator parameter of the operation of the cell. Consequently, the implementation of the control method according to the invention requires only a simple software adaptation of the present electronic modules.

Additionally, and advantageously according to the invention, in order to determine the threshold value of the ambient temperature of the environment in which the battery is located,

a mission profile representing the operating parameters of the proposed application is drawn up, and is designed to combine a temperature profile, a profile of current consumption per unit of time, and a profile of the forms of the current consumed,

an accelerated ageing test of the application is conducted, with the measurement and storage during this ageing test, of the variation in time of the ambient temperature for which a theoretical value of minimum voltage at the terminals of said battery is obtained, this minimum voltage being called the minimum operating voltage which guarantees the operation of the application.

The invention also covers a device for controlling the life of a battery such as a cell, particularly a lithium/manganese cell, having specific operating characteristics, in the context of a given application in which said cell is used. According to the invention, this control device comprises:

a voltage raiser connected so as to be supplied electrically by the battery and adapted to make up for any deficiencies of the latter,

means of storing a threshold value of an indicator parameter of the operation of the battery, below which said battery is considered to be incapable of providing an adequate power supply to the application,

means of periodically measuring the indicator parameter,

and a control unit connected to the storage means and to the measurement means, and programmed to trigger the supply to the voltage raiser if, and only if, the measured value of the indicator parameter becomes less than the stored threshold value.

Other characteristic objects and advantages of the invention will be made clear by the following detailed description which refers to the attached drawings which represent a preferred embodiment of the invention by way of example and without restrictive intent. In these drawings:

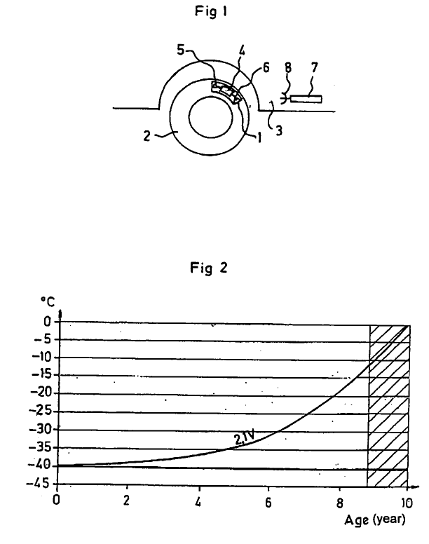

FIG. 1 is a partial and schematic lateral view of a vehicle equipped with a monitoring system incorporating a device for controlling the life of a cell according to the invention,

and FIG. 2 is a graph representing a curve representative of the variation in time of the minimum temperature for which a given voltage is obtained at the terminals of a cell of an electronic module of a monitoring system.

The monitoring system implementing the control method according to the invention is shown in FIG. 1 as being mounted on a vehicle 3 provided with four wheels 2, each fitted with a tire in a conventional way.

Such a monitoring system conventionally includes, in the first place, in association with each wheel 2, an electronic module such as 1, which for example is fixed to the rim of said wheel so as to be positioned inside the tire profile.

Each of these electronic modules 1 incorporates sensors dedicated to the measurement of parameters such as pressure, temperature, acceleration, etc., connected to a microprocessor computer unit 4 supplied electrically by means of a button cell 5 such as a lithium/manganese cell, and connected to an RF transmitter connected to a radio frequency antenna 6.

The monitoring system also comprises a centralized computer or central unit 7 having a microprocessor and incorporating an RF receiver for receiving the signals emitted by each of the four electronic modules 1, and connected for this purpose to an antenna 8.

Usually, such a monitoring system, and particularly its central unit 7, is designed so as to inform the driver of any abnormal change in the parameters measured by the sensors associated with the wheels 2.

According to the invention, the microprocessor computer unit 4 of each electronic module comprises:

a voltage raiser connected so as to be supplied electrically by the cell 5 and adapted to make up for any deficiencies of the latter,

means of storing threshold values of indicator parameters of the operation of the cell 5, below which said cell is considered to be incapable of providing an adequate power supply to the application,

and a control unit connected to the storage means and to the measurement sensors, and programmed to trigger the supply to the voltage raiser if, and only if, the measured values of the indicator parameters become less than the corresponding stored threshold values.

In the application described in the present document by way of example and without restrictive intent, the indicator parameters which are used consist of two parameters conventionally measured by the measurement sensors of the electronic modules 1, namely respectively:

the ambient temperature of the environment in which the cell 5 is located, and

the voltage at the terminals of said cell.

The threshold value of the voltage at the terminals of the cell 5 consists of a theoretical value of the minimum voltage at the terminals of said cell, called the minimum operating voltage, which can ensure the operation of the application. This threshold value is conventionally defined by the manufacturers of the components incorporated in the electronic modules 1, and has a mean value of the order of 2.1 volts in the context of the present example.

As for the threshold value of the ambient temperature, this is determined, as a function of the mean temperatures of the areas of operation of the vehicles 3 intended to be fitted with the electronic modules 1, on the basis of the analysis of the curve shown in FIG. 2.

This curve is found, in a preliminary step, by implementing a procedure of calibration of the type of cell 5 used in the context of the proposed application (electronic module 1 of a monitoring system), the calibration procedure consisting of:

drawing up a mission profile representing the operating parameters of the proposed application, designed to combine a temperature profile, a profile of current consumption per unit of time, and a profile of the forms of the current consumed,

and conducting an accelerated ageing test of the application, with the measurement and storage, during this ageing test, of the variation in time of the ambient temperature for which the minimum operating voltage is obtained.

In the example shown in FIG. 2, the threshold value of 2.1 volts is obtained for an ambient temperature of −40 degrees when the cell 5 is new; this threshold value is subsequently obtained for increasingly high ambient temperatures, reaching for example a value of the order of −10 degrees for a 9-year-old cell. In this example, a threshold value of the ambient temperature can be fixed at −15 degrees.

In the proposed application, the procedure for triggering the supply to the voltage raiser, based on the use of the aforesaid two indicator parameters, consists of:

periodically measuring the ambient temperature and comparing the measured value with the stored threshold value of −15 degrees,

if the measured ambient temperature is below the stored threshold value, measuring the voltage at the terminals of the cell 5 and comparing this measured voltage with the stored minimum operating value of 2.1 volts,

and triggering the supply to the voltage raiser only if the measured voltage is below the stored threshold voltage.

It should be noted that, in this procedure, the only measurements made periodically in a regular way are temperature measurements. These measurements are made and used in the context of the application of monitoring the operating parameters of the wheels 2, in order to compensate the measured values of these parameters, and therefore this first step of the control method according to the invention does not have any intrinsic electricity consumption.

Therefore, the only intrinsic electricity consumption induced by the control method according to the invention relates to voltage measurements only, which are only made very sporadically and which therefore require only a very low electricity consumption.

In conclusion, the control method according to the invention makes it possible:

to guarantee that the minimum operating value of the application is obtained throughout the life of the cell 5,

to considerably increase the life of the cell 5 by comparison with a method in which the supply to the voltage raiser is systematically triggered. By way of illustration, this increased life is shown by the hachuring in FIG. 2, and can correspond to a period of the order of 12 to 18 months.

1. A method of controlling the life of a battery (5) such as a cell, particularly a lithium/manganese cell, having specific operating characteristics, in the context of a given application in which said battery is used, said control method including the following steps:
incorporating into the application a voltage raiser electrically supplied by the battery (5) and adapted to make up for any deficiencies in the latter,
selecting as the indicator parameter of the operation of the battery (5) the ambient temperature of the environment in which the battery (5) is located, and fixing and storing as the threshold value of said temperature a predetermined value of ambient temperature below which the battery is incapable of guaranteeing that the minimum operating voltage of the application will be obtained throughout its life,
periodically measuring the indicator parameter and triggering the supply to the voltage raiser if, and only if, the measured value of said indicator parameter becomes lower than the stored threshold value, said method being characterized in that, in order to determine the threshold value of the ambient temperature of the environment in which the battery (5) is located,
a mission profile representing the operating parameters of the proposed application is drawn up, and is designed to combine a temperature profile, a profile of current consumption per unit of time, and a profile of the forms of the current consumed,
an accelerated ageing test of the application is conducted, with the measurement and storage during this ageing test, of the variation in time of the ambient temperature for which a theoretical value of minimum voltage at the terminals of said battery is obtained, this minimum voltage being called the minimum operating voltage which guarantees the operation of the application.

2. The control method as claimed in claim 1, characterized in that:
a second indicator parameter, consisting of the voltage at the terminals of said battery, is selected,
and, if a temperature below the corresponding threshold value is measured, the value of the second indicator parameter is measured and the supply to the voltage raiser is triggered if, and only if, the measured value of said second indicator parameter becomes lower than the corresponding stored threshold value.

3. The method as claimed in claim 1 for controlling the life of a cell (5), particularly a lithium/manganese cell, incorporated in an electronic module (1) adapted to be mounted on a wheel (2) of a vehicle (3) in order to measure operating parameters of said wheel and transmit them towards a central unit (7) mounted on said vehicle, said control method being characterized in that a parameter measured by the electronic module (1) in the context of its monitoring application is additionally selected as the indicator parameter of the operation of the cell (5).

4. The method as claimed in claim 2 for controlling the life of a cell (5), particularly a lithium/manganese cell, incorporated in an electronic module (1) adapted to be mounted on a wheel (2) of a vehicle (3) in order to measure operating parameters of said wheel and transmit them towards a central unit (7) mounted on said vehicle, said control method being characterized in that a parameter measured by the electronic module (1) in the context of its monitoring application is additionally selected as the indicator parameter of the operation of the cell (5).
